(19) United States
(12) Patent Application Publication
(10) Pub. No.: US 2025/0092492 A1
(43) Pub. Date: Mar. 20, 2025

(54) RECYCLED 6063 ALUMINUM ALLOY MATERIAL, PREPARATION METHOD THEREFOR AND USE THEREOF

(71) Applicant: Lanto Electronic Limited, Kunshan City (CN)

(72) Inventors: Zekun SHI, Kunshan City (CN); Xin TIAN, Kunshan City (CN); KHER HOW LEE, Kunshan City (CN)

(73) Assignee: Lanto Electronic Limited, Kunshan City (CN)

(21) Appl. No.: 18/632,797

(22) Filed: Apr. 11, 2024

(30) Foreign Application Priority Data
Sep. 15, 2023 (CN) 202311196878.2

(51) Int. Cl. C22C 21/08; C22C 1/02; C22C 1/03; C22F 1/047

(52) U.S. Cl. CPC C22C 21/08; C22C 1/026; C22C 1/03; C22F 1/047

(57) ABSTRACT

Provided are a recycled 6063 aluminum alloy material, a preparation method therefor and use thereof. In mass percent, the recycled 6063 aluminum alloy material comprises 0.40-0.44 wt % of Si, 0.53-0.57 wt % of Mg, 0.015-0.025 wt % of Mn, 0.02 wt % or less of Cu, 0.12 wt % or less of Fe, 0.02 wt % or less of Zn, 0.015-0.025 wt % of Ti, 0.01 wt % or less of Cr, 0.02 wt % or less of V and a remainder of Al; and the recycled 6063 aluminum alloy material contains 75-85 wt % of recycled aluminum scrap. In the present application, the recycled aluminum scrap is used as raw material to prepare the 6063 aluminum alloy material, which realizes the green and low-carbon manufacturing of 6063 aluminum alloy compared with the conventional process, and achieves the purpose of energy conservation and emission reduction.

### CROSS-REFERENCE TO RELATED APPLICATION(S)

This application claims priority to Chinese Patent Application No. 202311196878.2 filed Sep. 15, 2023, the disclosure of which is incorporated herein by reference in its entirety.

### TECHNICAL FIELD

The present application belongs to the technical field of metal metallurgy and processing, and specifically relates to a recycled 6063 aluminum alloy material, a preparation method therefor and use thereof.

### BACKGROUND

The main alloying elements of 6063 aluminum alloy are magnesium and silicon, and 6063 aluminum alloy has excellent workability, great weldability, great extrudability, great plating performance, good corrosion resistance, and good toughness as well as various other advantages such as easy to polish and coat coloring films, and having good anodic oxidation effects, which is an exemplary extrusion alloy. 6063 Aluminum alloy profiles have been widely used in the field of consumer electronics due to the good plasticity, moderate strength for heat treatment, good weldability, gorgeous surface color after anodic oxidation treatment, and other advantages.

The conventional smelting process of 6063 aluminum alloy includes aluminum ore mining, alumina production, aluminum electrolysis smelting and aluminum material processing in sequence. Although aluminum materials with good performance can be obtained from simple raw materials by the conventional smelting process, the smelting process will cause large energy consumption and generate a large amount of greenhouse gases, resulting in resource waste and environmental pollution.

Due to the increasing demand and use of aluminum alloy materials in the field of consumer electronics, and under the environmental protection policy of energy conservation and emission reduction, recycling aluminum alloy scrap to produce aluminum alloy attracts great interest. The incorporation of recycled scrap reduces the cost and time associated with the production of primary aluminum and reduces carbon emission (e.g., reduces the global impact).

CN 115768912A discloses an aluminum alloy produced from recycled aluminum alloy scrap. The disclosed aluminum alloy contains up to 25% of primary aluminum alloy. In mass percent, the aluminum alloy comprises the following components: 0.50 wt %-3.00 wt % of Mg, 0.10 wt %-3.50 wt % of Si, 0.01 wt %-0.60 wt % of Fe, up to 1.20 wt % of Cu, 0.10 wt %-0.90 wt % of Mn, up to 0.20 wt % of Cr, up to 0.20 wt % of Ti, up to 0.10 wt % of V, up to 1.00 wt % of Zn, up to 0.15 wt % of impurities, and A1. Although the aluminum alloy provided in this patent discloses the preparation from recycled aluminum alloy scrap, the aluminum alloy is not 6063 aluminum alloy.

CN 113574192A discloses an aging and highly formable aluminum alloy and a preparation method therefor. The aluminum alloy provided in this patent contains at least 40 wt % recycled content. The aluminum alloy comprises the following components in mass percent: 0.5 wt %-1.6 wt % of Mg; 0.2 wt %-0.5 wt % of Si; up to 1.0 wt % of Fe; up to 0.5 wt % of Cu; up to 0.5 wt % of Mn; up to 0.3 wt % of Cr; up to 0.3 wt % of Ti; up to 0.5 wt % of Zn; up to 0.25 wt % of impurities; and Al. The aluminum alloy provided in this patent contains no less than 40 wt % recycled content, and there still will be a large amount of greenhouse gases generated from the smelting process, and the purpose of energy conservation and emission reduction cannot be achieved.

In order to further respond to the demand for aluminum alloy materials in the field of consumer electronics as well as the environmental protection policy of energy conservation and emission reduction, it is necessary to provide a type of 6063 aluminum alloy to meet the above needs.

### SUMMARY

The present application is to provide a recycled 6063 aluminum alloy material, a preparation method therefor and use thereof. The recycled 6063 aluminum alloy material conforms to the national AL6063 standards; and the preparation method has the advantages of saving production energy and reducing carbon emission.

In a first aspect, the present application provides a recycled 6063 aluminum alloy material, wherein in mass percent, the recycled 6063 aluminum alloy material comprises: 0.40-0.44 wt % of Si, 0.53-0.57 wt % of Mg, 0.015-0.025 wt % of Mn, 0.02 wt % or less of Cu, 0.12 wt % or less of Fe, 0.02 wt % or less of Zn, 0.015-0.025 wt % of Ti, 0.01 wt % or less of Cr, 0.02 wt % or less of V and a remainder of Al;

wherein the recycled 6063 aluminum alloy material contains 75-85 wt % of recycled aluminum scrap, which may be, for example, 75 wt %, 77 wt %, 79 wt %, 81 wt %, 83 wt % or 85 wt %, but is not limited to the listed values, and other unlisted values within the numerical range are also applicable.

In the present application, the recycled aluminum scrap is used to prepare the aluminum alloy material, and the aluminum alloy material obtained conforms to the national AL6063 standards, which achieves the purpose of energy conservation; in addition, the use of 75-85 wt % of recycled aluminum scrap to prepare the material of 6063 aluminum alloy reduces the carbon emission in the preparation process, which achieves the purpose of energy conservation and emission reduction.

Exemplarily, in the recycled 6063 aluminum alloy material of the present application, the Si has a content of 0.40-0.44 wt %, which may be, for example, 0.40 wt %, 0.41 wt %, 0.42 wt %, 0.43 wt % or 0.44 wt %, but is not limited to the listed values, and other unlisted values within the numerical range are also applicable.

The Mg has a content of 0.53-0.57 wt %, which may be, for example, 0.53 wt %, 0.54 wt %, 0.55 wt %, 0.56 wt % or 0.57 wt %, but is not limited to the listed values, and other unlisted values within the numerical range are also applicable.

The Mn has a content of 0.015-0.025 wt %, which may be, for example, 0.015 wt %, 0.017 wt %, 0.019 wt %, 0.021 wt %, 0.023 wt % or 0.025 wt %, but is not limited to the listed values, and other unlisted values within the numerical range are also applicable.

The Cu has a content of less than or equal to 0.02 wt %, which may be, for example, 0.02 wt %, 0.018 wt %, 0.014 wt %, 0.012 wt % or 0.008 wt %, but is not limited to the listed values, and other unlisted values within the numerical range are also applicable.

The Fe has a content of less than or equal to 0.12 wt %, which may be, for example, 0.12 wt %, 0.1 wt %, 0.08 wt %, 0.06 wt % or 0.04 wt %, but is not limited to the listed values, and other unlisted values within the numerical range are also applicable.

The Zn has a content of less than or equal to 0.02 wt %, which may be, for example, 0.02 wt %, 0.018 wt %, 0.014 wt %, 0.012 wt % or 0.008 wt %, but is not limited to the listed values, and other unlisted values within the numerical range are also applicable.

The Ti has a content of 0.015-0.025 wt %, which may be, for example, 0.015 wt %, 0.017 wt %, 0.019 wt %, 0.021 wt %, 0.023 wt % or 0.025 wt %, but is not limited to the listed values, and other unlisted values within the numerical range are also applicable.

The Cr has a content of less than or equal to 0.01 wt %, which may be, for example, 0.01 wt %, 0.008 wt %, 0.006 wt %, 0.004 wt % or 0.002 wt %, but is not limited to the listed values, and other unlisted values within the numerical range are also applicable.

The V has a content of less than or equal to 0.02 wt %, which may be, for example, 0.02 wt %, 0.018 wt %, 0.014 wt %, 0.012 wt % or 0.008 wt %, but is not limited to the listed values, and other unlisted values within the numerical range are also applicable.

As a preferred technical solution of the present application, the recycled aluminum scrap comprises any one or a combination of at least two of an e-cigarette shell, an obsolete computer shell or a ring-pull can; a typical but non-limiting combination comprises a combination of an e-cigarette shell and an obsolete computer shell, a combination of an e-cigarette shell and a ring-pull can, a combination of an obsolete computer shell and a ring-pull can, or a combination of an e-cigarette shell, an obsolete computer shell and a ring-pull can.

It is worth noting that there are no restrictions on the content of impurities contained in the recycled aluminum scrap used in the present application.

As a preferred technical solution of the present application, the recycled 6063 aluminum alloy material has a tensile strength of more than or equal to 240 MPa, which may be, for example, 240 MPa, 245 MPa, 250 MPa, 255 MPa or 260 MPa, but is not limited to the listed values, and other unlisted values within the numerical range are also applicable.

Preferably, the recycled 6063 aluminum alloy material has a yield strength of more than or equal to 210 MPa, which may be, for example, 210 MPa, 215 MPa, 220 MPa, 225 MPa or 230 MPa, but is not limited to the listed values, and other unlisted values within the numerical range are also applicable.

Preferably, the recycled 6063 aluminum alloy material has an elongation of more than or equal to 8%, which may be, for example, 8%, 9%, 10%, 11%, 12% or 13%, but is not limited to the listed values, and other unlisted values within the numerical range are also applicable.

Preferably, the recycled 6063 aluminum alloy material has a hardness of more than or equal to 85 HB, which may be, for example, 85 HB, 88 HB, 90 HB, 92 HB or 95 HB, but is not limited to the listed values, and other unlisted values within the numerical range are also applicable.

In a second aspect, the present application provides a preparation method for the recycled 6063 aluminum alloy material as provided by the first aspect, and the preparation method comprises the following steps:
(1) preparing recycled aluminum scrap and new aluminum ingots as raw materials;
(2) subjecting the recycled aluminum scrap in step (1) to pre-treatment, and then melting to obtain a recycled aluminum melt; and
(3) mixing the new aluminum ingots with the recycled aluminum melt obtained in step (2) for alloy composition proportioning, and then performing ingot casting, thermal processing and mechanical processing in sequence to obtain the recycled 6063 aluminum alloy material.

The present application adopts recycled aluminum scrap as raw material to prepare the material of 6063 aluminum alloy, which realizes the green and low-carbon manufacturing of 6063 aluminum alloy compared with the conventional process.

As a preferred technical solution of the present application, the recycled aluminum scrap has a content of 75-85 wt % in the raw materials in step (1), which may be, for example, 75 wt %, 77 wt %, 79 wt %, 81 wt %, 83 wt % or 85 wt %, but is not limited to the listed values, and other unlisted values within the numerical range are also applicable.

Preferably, the new aluminum ingots in step (1) comprise: 1.0 wt % or less of Fe+Si, 0.1 wt % or less of Cr, 0.1 wt % or less of Cu, 0.1 wt % or less of Mg, 0.1 wt % or less of Mn, 0.1 wt % or less of Ni, 0.1 wt % or less of Zn, and a remainder of Al.

It is worth noting that in the new aluminum ingots of the present application, if the contents of Cr and Mn are both less than or equal to 0.05 wt %, the content of Cu is allowed to be 0.10-0.20 wt %.

Exemplarily, in the new aluminum ingots of the present application, the Fe+Si has a content of less than or equal to 1.0 wt % which may be, for example, 1.0 wt %, 0.8 wt %, 0.6 wt %, 0.4 wt % or 0.2 wt %, but is not limited to the listed values, and other unlisted values within the numerical range are also applicable.

The Cr has a content of less than or equal to 0.1 wt %, which may be, for example, 0.1 wt %, 0.08 wt %, 0.07 wt %, 0.05 wt % or 0.03 wt %, but is not limited to the listed values, and other unlisted values within the numerical range are also applicable.

The Cu has a content of less than or equal to 0.1 wt %, which may be, for example, 0.1 wt %, 0.08 wt %, 0.07 wt %, 0.05 wt % or 0.03 wt %, but is not limited to the listed values, and other unlisted values within the numerical range are also applicable.

The Mg has a content of less than or equal to 0.1 wt %, which may be, for example, 0.1 wt %, 0.08 wt %, 0.07 wt %, 0.05 wt % or 0.03 wt %, but is not limited to the listed values, and other unlisted values within the numerical range are also applicable.

The Mn has a content of less than or equal to 0.1 wt %, which may be, for example, 0.1 wt %, 0.08 wt %, 0.07 wt %, 0.05 wt % or 0.03 wt %, but is not limited to the listed values, and other unlisted values within the numerical range are also applicable.

The Ni has a content of less than or equal to 0.1 wt %, which may be, for example, 0.1 wt %, 0.08 wt %, 0.07 wt %, 0.05 wt % or 0.03 wt %, but is not limited to the listed values, and other unlisted values within the numerical range are also applicable.

The Zn has a content of less than or equal to 0.1 wt %, which may be, for example, 0.1 wt %, 0.08 wt %, 0.07 wt %, 0.05 wt % or 0.03 wt %, but is not limited to the listed values, and other unlisted values within the numerical range are also applicable.

As a preferred technical solution of the present application, the pre-treatment in step (2) comprises rough separation, cleaning treatment and sorting treatment in sequence.

Preferably, the cleaning treatment is to achieve a result that greasy dirt and coating on the surface of the recycled aluminum scrap are removed.

Preferably, the sorting treatment is to remove any one or a combination of at least two of a non-metallic foreign material, a non-ferrous foreign material or a magnetic foreign material from the recycled aluminum scrap.

It is worth noting that the rough separation of the present application comprises: separately recycling cast aluminum alloys and wrought aluminum alloys in the recycled aluminum scrap, and separating thin aluminum scrap and bulky aluminum scrap, and thus the aluminum materials can be melted and treated separately in the subsequent process, reducing ablation loss caused by directly exposing aluminum of high temperature by the thin aluminum scrap. The cleaning treatment of the present application is to clean the recycled aluminum scrap and remove its paint coating by the methods of thermal paint removal, chemical paint removal or mechanical paint removal, which can reduce the harmful gas emission in the recycling process of recycled aluminum scrap, and improve the proportion of the recycled aluminum in recycled aluminum scrap and the mechanical properties of the recycled aluminum alloy. The sorting treatment of the present application is to remove the non-metallic foreign material by air separation, flotation, etc., and remove the magnetic foreign material by magnetic sorting, and remove other non-ferrous metal foreign material by heavy media and eddy current.

As a preferred technical solution of the present application, a hydrogen content of the recycled aluminum melt in step (2) is (0.1-0.15) mL/100 g Al, which may be, for example, 0.1 mL/100 g Al, 0.2 mL/100 g Al, 0.3 mL/100 g Al, 0.4 mL/100 g Al or 0.5 mL/100 g Al, but is not limited to the listed values, and other unlisted values within the numerical range are also applicable.

Preferably, a total content of the foreign materials of the recycled aluminum melt in step (2) is less than 0.02 mm²/kg, which may be, for example, 0.01 mm²/kg, 0.015 mm²/kg or 0.018 mm²/kg, but is not limited to the listed values

It is worth noting that the recycled aluminum scrap is easy to react with water vapor in the air during the melting process, resulting in oxidative ablation, and lowering the yield of the recycled aluminum alloy; the foreign materials will reduce the mechanical properties of the recycled aluminum alloy; in the present application, a two-stage panel filtration of 60-mesh or 80-mesh is used on the melt to remove foreign materials in order to purify the melt.

As a preferred technical solution of the present application, the alloy composition proportioning in step (3) is to achieve a result that in the system, Si has a content of 0.4-0.44 wt %, which may be, for example, 0.4 wt %, 0.41 wt %, 0.42 wt %, 0.43 wt % or 0.44 wt %, but is not limited to the listed values, and other unlisted values within the numerical range are also applicable; Mg has a content of 0.53-0.57 wt %, which may be, for example, 0.53 wt %, 0.54 wt %, 0.55 wt %, 0.56 wt or 0.57 wt %, but is not limited to the listed values, and other unlisted values within the numerical range are also applicable; Mn has a content of 0.015-0.025 wt %, which may be, for example, 0.015 wt %, 0.017 wt % 0.019 wt %, 0.021 wt %, 0.023 wt % or 0.025 wt %, but is not limited to the listed values, and other unlisted values within the numerical range are also applicable; and Cr has a content of less than or equal to 0.01 wt %, which may be, for example, 0.01 wt %, 0.008 wt %, 0.006 wt %, 0.004 wt % or 0.002 wt %, but is not limited to the listed values, and other unlisted values within the numerical range are also applicable.

In the present application, the alloy composition of the recycled aluminum melt obtained in step (2) is adjusted by adding new aluminum ingots to satisfy the elemental contents of 6063 aluminum alloy.

As a preferred technical solution of the present application, the thermal processing in step (3) comprises solution treatment, aging treatment and hot extrusion molding in sequence.

Preferably, the solution treatment is performed at 450-500° C., which may be, for example, 450° C., 460° C., 470° C., 480° C., 490° C. or 500° C., but is not limited to the listed values, and other unlisted values within the numerical range are also applicable.

Preferably, the solution treatment is performed for 50-80 min, which may be, for example, 50 min, 60 min, 70 min or 80 min, but is not limited to the listed values, and other unlisted values within the numerical range are also applicable.

Preferably, the aging treatment comprises primary aging treatment and secondary aging treatment in sequence.

Compared with single-stage aging treatment, the two-stage aging treatment provided by the present application is more capable of improving the recycled 6063 aluminum alloy material in structure homogeneity, toughness and corrosion resistance.

Preferably, the primary aging treatment is performed at 100-140° C., which may be, for example, 100° C., 110° C., 120° C., 130° C. or 140° C., but is not limited to the listed values, and other unlisted values within the numerical range are also applicable.

Preferably, the primary aging treatment is performed for 10-14 h, which may be, for example, 10 h, 11 h, 12 h, 13 h or 14 h, but is not limited to the listed values, and other unlisted values within the numerical range are also applicable.

Preferably, the secondary aging treatment is performed at 160-200° C., which may be, for example, 160° C., 170° C., 180° C., 190° C. or 200° C., but is not limited to the listed values, and other unlisted values within the numerical range are also applicable.

Preferably, the secondary aging treatment is performed for 2-5 h, which may be, for example, 2 h, 2.5 h, 3 h, 3.5 h, 4 h, 4.5 h or 5 h, but is not limited to the listed values, and other unlisted values within the numerical range are also applicable.

Preferably, the hot extrusion molding has an extrusion rate of 60-80 m/s, which may be, for example, 60 m/s, 65 m/s, 70 m/s, 75 m/s or 80 m/s, but is not limited to the listed values, and other unlisted values within the numerical range are also applicable.

The extrusion rate of the hot extrusion molding of the present application is 60-80 m/s. In the present application, the internal stress of the recycled 6063 aluminum alloy material can be eliminated by appropriately determining the extrusion rate, and its shear strength can be improved; the hot extrusion of the present application can also enhance the subsequent surface treatment effect of the recycled 6063 aluminum alloy, such as coloring treatment, anodic oxidation and the like.

In the present application, thin-walled aluminum shells of 3-6 mm can be manufactured and produced by subjecting the aluminum alloy material to mechanical processing, and the surface of the aluminum alloy material can be subjected to anodic oxidation coloring, so as to satisfy the processing conditions and performance requirements of the shells of the consumer electronic product, and realize the low-carbon process of preparing the shells and components of the consumer electronic product.

As a preferred technical solution of the present application, the second aspect of the present application provides a preparation method for the recycled 6063 aluminum alloy material which comprises the following steps:
(1) preparing recycled aluminum scrap and new aluminum ingots as raw materials; wherein the recycled aluminum scrap has a content of 75-85 wt % in the raw materials;
(2) subjecting the recycled aluminum scrap in step (1) to pre-treatment, and then melting to obtain a recycled aluminum melt;
the pre-treatment comprises rough separation, cleaning treatment and sorting treatment in sequence; the cleaning treatment is to achieve a result that greasy dirt and coating on the surface of the recycled aluminum scrap are removed; and the sorting treatment is to remove a non-metallic foreign material, a non-ferrous foreign material or a magnetic foreign material from the recycled aluminum scrap;
a hydrogen content of the recycled aluminum melt is (0.1-0.15) mL/100 g Al, and a total content of the foreign materials is less than 0.02 mm²/kg;
(3) mixing the new aluminum ingots with the recycled aluminum melt obtained in step (2) for alloy composition proportioning, and then performing ingot casting, thermal processing and mechanical processing in sequence to obtain the recycled 6063 aluminum alloy material;
wherein the alloy composition proportioning is to achieve a result that in the system, Si has a content of 0.4-0.44 wt %, Mg has a content of 0.53-0.57 wt %, Mn has a content of 0.015-0.025 wt %, and Cr has a content of less than or equal to 0.01 wt %;
the thermal processing comprises solution treatment, aging treatment and hot extrusion molding in sequence; the solution treatment is performed at 450-500° C. for 50-80 min; the aging treatment comprises primary aging treatment and secondary aging treatment in sequence; the primary aging treatment is performed at 100-140° C. for 10-14 h; the secondary aging treatment is performed at 160-200° C. for 2-5 h; and the hot extrusion molding has an extrusion rate of 60-80 m/s.

In a third aspect, the present application provides a use of the recycled 6063 aluminum alloy material as provided by the first aspect, wherein the recycled 6063 aluminum alloy material is used as a material for a shell and/or a structural component of a consumer electronic product.

The consumer electronic product comprises any one or a combination of at least two of an electronic atomizer product, a laptop computer, a mobile phone, a Pad, a hair dryer or a television set; a typical but non-limiting combination comprises a combination of an electronic atomizer product, a laptop computer, a mobile phone or a Pad, a combination of an electronic atomizer product and a hair dryer, a combination of a laptop computer, a mobile phone, a Pad and a television set, or a combination of an electronic atomizer product, a laptop computer, a mobile phone, a Pad, a hair dryer and a television set.

The numerical ranges of the present application comprise not only the point values listed above, but also any unlisted point values within the numerical ranges. For the space limitation and conciseness reason of the present application, the specific point values included in the ranges will not be exhaustively enumerated in the present application.

Compared with the prior art, the beneficial effects of the present application include:
(1) in the present application, the recycled 6063 aluminum alloy material is prepared from 75-85 wt % of recycled aluminum scrap as raw material, and thereby the preparation method has the advantages of saving production energy and reducing carbon emission; and
(2) the recycled 6063 aluminum alloy material provided by the present application conforms to the national A16063 standards and has good physical properties.

### DETAILED DESCRIPTION

Technical solutions of the present application are further described below in terms of specific embodiments. It should be clear to those skilled in the art that the examples are merely used for a better understanding of the present application and should not be construed as a specific limitation to the present application.

### Example 1

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material comprises the following steps:

(1) recycled aluminum scrap and new aluminum ingots were prepared as raw materials; wherein the recycled aluminum scrap had a content of 80 wt % in the raw materials;
(2) the recycled aluminum scrap in step (1) was subjected to pre-treatment and then melted to obtain a recycled aluminum melt;
the pre-treatment included rough separation, cleaning treatment and sorting treatment in sequence; the cleaning treatment achieved a result that greasy dirt and coating on the surface of the recycled aluminum scrap were removed; and the sorting treatment removed a non-metallic foreign material, a non-ferrous foreign material or a magnetic foreign material from the recycled aluminum scrap;
a hydrogen content of the recycled aluminum melt was 0.125 mL/100 g Al, and a total content of the foreign materials was less than 0.02 mm²/kg;
(3) the new aluminum ingots and the recycled aluminum melt obtained in step (2) were mixed for alloy composition proportioning, and then subjected to ingot casting, thermal processing and mechanical processing in sequence to obtain the recycled 6063 aluminum alloy material;
wherein the alloy composition proportioning achieved a result that in the system, Si had a content of 0.4-0.44 wt %, Mg had a content of 0.54 wt %, Mn had a content of 0.02 wt %, and Cr had a content of 0.008 wt %; and
the thermal processing included solution treatment, aging treatment and hot extrusion molding in sequence; the solution treatment was performed at 480° C. for 60 min; the aging treatment included primary aging treatment and secondary aging treatment in sequence; the primary aging treatment was performed at 120° C. for 12 h; the secondary aging treatment was performed at 180° C. for 3 h; and the hot extrusion molding had an extrusion rate of 70 m/s.

### Example 2

This example provides a recycled 6063 aluminum alloy material, and in mass percent, the recycled 6063 aluminum alloy material comprises 0.40 wt % of Si, 0.53 wt % of Mg, 0.015 wt % of Mn, 0.02 wt % of Cu, 0.12 wt % of Fe, 0.02 wt % of Zn, 0.015 wt % of Ti, 0.01 wt % of Cr, 0.018 wt % of V and a remainder of Al.

A preparation method for the recycled 6063 aluminum alloy material comprises the following steps:
(1) recycled aluminum scrap and new aluminum ingots were prepared as raw materials; wherein the recycled aluminum scrap had a content of 75 wt % in the raw materials;
(2) the recycled aluminum scrap in step (1) was subjected to pre-treatment and then melted to obtain a recycled aluminum melt;
the pre-treatment included rough separation, cleaning treatment and sorting treatment in sequence; the cleaning treatment achieved a result that greasy dirt and coating on the surface of the recycled aluminum scrap were removed; and the sorting treatment removed a non-metallic foreign material, a non-ferrous foreign material or a magnetic foreign material from the recycled aluminum scrap;
a hydrogen content of the recycled aluminum melt was 0.1 mL/100 g Al, and a total content of the foreign materials was less than 0.02 mm²/kg;
(3) the new aluminum ingots and the recycled aluminum melt obtained in step (2) were mixed for alloy composition proportioning, and then subjected to ingot casting, thermal processing and mechanical processing in sequence to obtain the recycled 6063 aluminum alloy material;
wherein the alloy composition proportioning achieved a result that in the system, Si had a content of 0.4 wt %, Mg had a content of 0.53 wt %, Mn had a content of 0.015 wt %, and Cr had a content of 0.01 wt %;
the thermal processing included solution treatment, aging treatment and hot extrusion molding in sequence; the solution treatment was performed at 400° C. for 80 min; the aging treatment included primary aging treatment and secondary aging treatment in sequence; the primary aging treatment was performed at 100° C. for 14 h; the secondary aging treatment was performed at 160° C. for 5 h; and the hot extrusion molding had an extrusion rate of 60 m/s.

### Example 3

This example provides a recycled 6063 aluminum alloy material, and in mass percent, the recycled 6063 aluminum alloy material comprises 0.44 wt % of Si, 0.57 wt % of Mg, 0.025 wt % of Mn, 0.012 wt % of Cu, 0.10 wt % of Fe, 0.012 wt % of Zn, 0.025 wt % of Ti, 0.005 wt % of Cr, 0.012 wt % of V and a remainder of Al.

A preparation method for the recycled 6063 aluminum alloy material comprises the following steps:
(1) recycled aluminum scrap and new aluminum ingots were prepared as raw materials; wherein the recycled aluminum scrap had a content of 85 wt % in the raw materials;
(2) the recycled aluminum scrap in step (1) was subjected to pre-treatment and then melted to obtain a recycled aluminum melt;
the pre-treatment included rough separation, cleaning treatment and sorting treatment in sequence; the cleaning treatment achieved a result that greasy dirt and coating on the surface of the recycled aluminum scrap were removed; the sorting treatment removed a non-metallic foreign material, and a non-ferrous foreign material or a magnetic foreign material from the recycled aluminum scrap;
a hydrogen content of the recycled aluminum melt was 0.15 mL/100 g Al, and a total content of the foreign materials was less than 0.02 mm²/kg;
(3) the new aluminum ingots and the recycled aluminum melt obtained in step (2) were mixed for alloy composition proportioning, and then subjected to ingot casting, thermal processing and mechanical processing in sequence to obtain the recycled 6063 aluminum alloy material;
wherein the alloy composition proportioning achieved a result that in the system, Si had a content of 0.44 wt %, Mg had a content of 0.57 wt %, Mn had a content of 0.025 wt %, and Cr had a content of 0.005 wt %;
the thermal processing included solution treatment, aging treatment and hot extrusion molding in sequence; the solution treatment was performed at 500° C. for 50 min; the aging treatment included primary aging treatment and secondary aging treatment in sequence; the primary aging treatment was performed at 140° C. for 10 h; the secondary aging treatment was performed at 200° C. for 2 h; and the hot extrusion molding had an extrusion rate of 80 m/s.

### Example 4

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the aging treatment in step (3) was changed to single-stage aging treatment which was performed at 150° C. for 15 h.

### Example 5

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the temperature of the solution treatment in step (3) was changed to 400° C.

### Example 6

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the temperature of the solution treatment in step (3) was changed to 550° C.

### Example 7

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the extrusion rate of the hot extrusion molding in step (3) was changed to 50 m/s.

### Example 8

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the extrusion rate of the hot extrusion molding in step (3) was changed to 90 m/s.

### Example 9

This example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the process of pre-treatment in step (2) was omitted.

### Comparative Example 1

This comparative example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the content of the recycled aluminum scrap in step (1) was changed to 70 wt %.

### Comparative Example 2

This comparative example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material differs from Example 1 only in that:
in this example, the content of the recycled aluminum scrap in step (1) was changed to 90 wt %.

### Comparative Example 3

This comparative example provides a recycled 6063 aluminum alloy material, and in mass percent, the recycled 6063 aluminum alloy material comprises 0.42 wt % of Si, 0.54 wt % of Mg, 0.02 wt % of Mn, 0.02 wt % or less of Cu, 0.1 wt % of Fe, 0.015 wt % of Zn, 0.02 wt % of Ti, 0.008 wt % of Cr, 0.02 wt % of V and a remainder of Al.

A preparation method for the recycled 6063 aluminum alloy material comprises that the new aluminum ingots were subjected to aluminum electrolysis smelting and then thermal processing to obtain the material of 6063 aluminum alloy.

The thermal processing comprises that smelted aluminum liquid was subjected to refining, casting and homogenization treatment in sequence.

The recycled materials of 6063 aluminum alloy provided by the above examples and comparative examples are tested for the physical properties and the carbon emissions in the preparation process, the results of which are shown in Table 1 and Table 2, respectively.

TABLE 1

| | Tensile | Yield | | | Shear |
|---|---|---|---|---|---|
| | strength/ | strength/ | Elonga- | Hardness/ | strength/ |
| / | MPa | MPa | tion/% | HB | MPa |
| Example 1 | 254 | 227 | 8.5 | 95 | 180 |
| Example 2 | 245 | 218 | 8.2 | 90 | 176 |
| Example 3 | 252 | 226 | 8.4 | 88 | 174 |
| Example 4 | 254 | 225 | 7.5 | 92 | 165 |
| Example 5 | 245 | 212 | 7.2 | 75 | 168 |
| Example 6 | 225 | 207 | 6.2 | 70 | 152 |
| Example 7 | 243 | 215 | 8.2 | 88 | 148 |
| Example 8 | 251 | 224 | 8.1 | 90 | 157 |
| Example 9 | 245 | 205 | 8.1 | 80 | 165 |
| Comparative | 255 | 225 | 8.2 | 90 | 172 |
| Example 1 | | | | | |
| Comparative | 242 | 231 | 8.2 | 92 | 180 |
| Example 2 | | | | | |
| Comparative | 251 | 223 | 8.1 | 82 | 181 |
| Example 3 | | | | | |

TABLE 2

| | Carbon emission (t/t) |
|---|---|
| Example 1 | 1.89 |
| Example 2 | 1.98 |
| Example 3 | 2.04 |
| Example 4 | 2.08 |
| Example 5 | 2.15 |
| Example 6 | 2.17 |
| Example 7 | 2.06 |
| Example 8 | 1.96 |
| Example 9 | 1.97 |
| Comparative Example 1 | 4.46 |
| Comparative Example 2 | 3.27 |
| Comparative Example 3 | 4.52 |

The following points can be seen by analyzing Table 1 and Table 2.
(1) By comprehensively analyzing Examples 1-3, it can be found that the recycled 6063 aluminum alloy material provided by the present application has good physical properties, and besides, the carbon emission of the preparation process is low, the preparation method has the advantage of being green and low-carbon emission;
(2) By analyzing Example 1 and Example 4, it can be found that the selection of single-stage aging treatment causes the aluminum alloy to deteriorate in composition uniformity and in turn affects its plasticity and toughness;
(3) By analyzing Example 1 and Examples 5-6, it can be found that the temperature of the solution treatment affects the physical properties of the aluminum alloy, and an overly high temperature leads to grain growth of the material and in turn reduces the strength and toughness of the material, while an overly low temperature cannot achieve the desired treatment result;
(4) By analyzing Example 1 and Examples 7-8, it can be found that the extrusion rate of the hot extrusion molding affects the physical properties of the aluminum alloy, and a high rate leads to an uneven internal structure of the aluminum alloy, and also leads to cracks on its surface;
(5) By analyzing Example 1 and Example 9, it can be found that omitting the pre-treatment process makes the recycled aluminum scrap unevenly heated, and results in material loss.

The above specific examples provide a further detailed description of the objects, technical solutions and beneficial effects of the present application. It should be understood that the above contents are only specific examples of the present application and are not intended to limit the present application. Any modifications, equivalent replacements, improvements, etc. made within the concept and principles of the present application shall fall within the protection scope of the present application.

What is claimed is:

1. A recycled 6063 aluminum alloy material, which, in mass percent, comprises: 0.40-0.44 wt % of Si, 0.53-0.57 wt % of Mg, 0.015-0.025 wt % of Mn, 0.02 wt % or less of Cu, 0.12 wt % or less of Fe, 0.02 wt % or less of Zn, 0.015-0.025 wt % of Ti, 0.01 wt % or less of Cr, 0.02 wt % or less of V and a remainder of Al;
wherein the recycled 6063 aluminum alloy material contains 75-85 wt % of recycled aluminum scrap.

2. The recycled 6063 aluminum alloy material according to claim 1, wherein the recycled aluminum scrap comprises any one or a combination of at least two of an e-cigarette shell, an obsolete computer shell or a ring-pull can.

3. The recycled 6063 aluminum alloy material according to claim 1, wherein the recycled 6063 aluminum alloy material has a tensile strength of more than or equal to 240 MPa;
wherein the recycled 6063 aluminum alloy material has a yield strength of more than or equal to 210 MPa;
wherein the recycled 6063 aluminum alloy material has an elongation of more than or equal to 8%;
wherein the recycled 6063 aluminum alloy material has a hardness of more than or equal to 85 HB.

4. A preparation method for the recycled 6063 aluminum alloy material according to claim 1, comprising the following steps:
(1) preparing recycled aluminum scrap and new aluminum ingots as raw materials;
(2) subjecting the recycled aluminum scrap in step (1) to pre-treatment, and then melting to obtain a recycled aluminum melt; and
(3) mixing the new aluminum ingots with the recycled aluminum melt obtained in step (2) for alloy composition proportioning, and then performing ingot casting, thermal processing and mechanical processing in sequence to obtain the recycled 6063 aluminum alloy material.

5. The preparation method according to claim 4, wherein the recycled aluminum scrap has a content of 75-85 wt % in the raw materials in step (1).

6. The preparation method according to claim 4, wherein in mass percent, the new aluminum ingots in step (1) comprise 1.0 wt % or less of Fe+Si, 0.1 wt % or less of Cr, 0.1 wt % or less of Cu, 0.1 wt % or less of Mg, 0.1 wt % or less of Mn, 0.1 wt % or less of Ni, 0.1 wt % or less of Zn, and a remainder of Al.

7. The preparation method according to claim 4, wherein the pre-treatment in step (2) comprises rough separation, cleaning treatment and sorting treatment in sequence;
wherein the cleaning treatment is to achieve a result that greasy dirt and coating on the surface of the recycled aluminum scrap are removed;
wherein the sorting treatment is to remove any one or a combination of at least two of a non-metallic foreign material, a non-ferrous foreign material or a magnetic foreign material from the recycled aluminum scrap.

8. The preparation method according to claim 4, wherein a hydrogen content of the recycled aluminum melt in step (2) is (0.1-0.15) mL/100 g Al.

9. The preparation method according to claim 4, wherein a total content of the foreign materials of the recycled aluminum melt in step (2) is less than 0.02 mm²/kg.

10. The preparation method according to claim 4, a two-stage panel filtration of 60-mesh or 80-mesh is used on the melt to remove foreign materials in step (2), in order to purify the melt.

11. The preparation method according to claim 4, wherein the alloy composition proportioning in step (3) is to achieve a result that in the system, Si has a content of 0.4-0.44 wt %, Mg has a content of 0.53-0.57 wt %, Mn has a content of 0.015-0.025 wt %, and Cr has a content of less than or equal to 0.01 wt %.

12. The preparation method according to claim 4, wherein the thermal processing in step (3) comprises solution treatment, aging treatment and hot extrusion molding in sequence.

13. The preparation method according to claim 4, wherein the solution treatment is performed at 450-500° C.;
the solution treatment is performed for 50-80 min.

14. The preparation method according to claim 4, the aging treatment comprises primary aging treatment and secondary aging treatment in sequence;
the primary aging treatment is performed at 100-140° C.;
the primary aging treatment is performed for 10-14 h.

15. The preparation method according to claim 4, the secondary aging treatment is performed at 160-200° C.;
the secondary aging treatment is performed for 2-5 h.

16. The preparation method according to claim 4, the hot extrusion molding has an extrusion rate of 60-80 m/s.

17. The recycled 6063 aluminum alloy material of claim 1 for use in a shell and/or a structural component of a consumer electronic product.
